(19) United States
(12) Patent Application Publication
(10) Pub. No.: US 2008/0190732 A1
(43) Pub. Date: Aug. 14, 2008

(54) Passenger Conveying System Comprising a Synchronous Linear Motor

(75) Inventors: Gerhard Matscheko, Starnberg (DE); Thorsten Rabenschlag, Vierkirchen (DE); Hubert Schedler, Karlsfeld (DE); Johannes Wollenberg, Grafelfing (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/911,558

(22) PCT Filed: Apr. 11, 2006
(86) PCT No.: PCT/EP06/61526

§ 371 Date: Oct. 15, 2007

(30) Foreign Application Priority Data
Apr. 15, 2005 (DE) 10 2005 017 500.7

(51) Int. Cl. B60L 13/04; B65G 35/00; B66B 21/02; B66B 9/02

(52) U.S. Cl. 198/321; 198/619; 104/281; 187/250

(57) ABSTRACT

The aim of the invention is to make person conveying systems more simple and less expensive. Said aim is achieved by equipping a person conveying system with a synchronous linear motor comprising a rack-shaped, permanent magnet-less secondary part (S) for driving purposes while the primary part of the synchronous linear motor is fixed to the conveying device (K) in or on which persons can be conveyed. If the person conveying system is embodied as a magnetic levitation railway, the synchronous linear motor makes it possible to conserve a significant amount of energy as opposed to an asynchronous linear motor as the permanent magnets provide a certain basic magnetic flux that can be used for supporting the railway car and driving the same in the direction of travel.

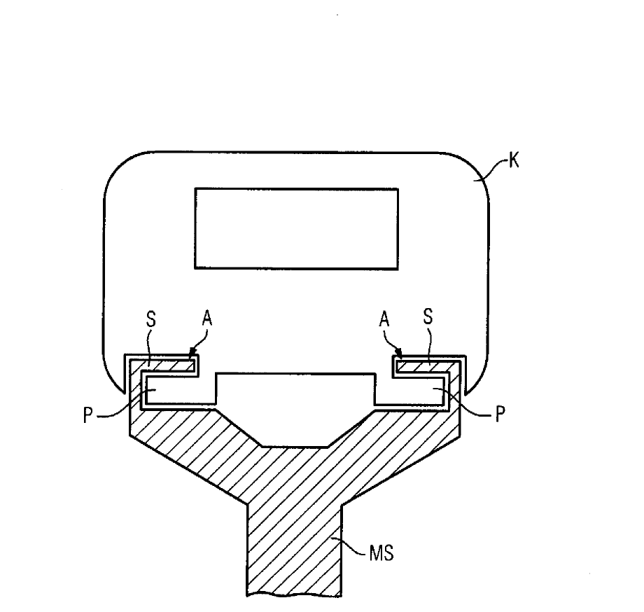

The present invention relates to a passenger conveying system comprising a transport device, in or on which passengers can be conveyed, and an electric motor for driving the transport device.

Systems for conveying passengers such as railroads, elevators and escalators are usually operated by rotary electric motors. In certain cases, asynchronous linear motors are also used for driving purposes. However, these often have a comparatively high energy consumption with a given air gap.

In principle, synchronous linear motors are also known as an alternative to the asynchronous linear motors. In this case, a secondary part in the form of a toothed rack with permanent magnets is laid in the displacement path, via which secondary part the primary part of the synchronous linear motor is moved. However, the contamination of the secondary part is problematic since ferroelectric particles remain adhered to the permanent magnets.

In addition, the German patent application DE 10 2004 045992.4 has disclosed a synchronous linear motor comprising a secondary part without any permanent magnets. Here, the permanent magnets are fitted to the primary part of the synchronous linear motor, so that the secondary part does not itself contribute to the production of a magnetic field.

The object of the present invention consists in providing a passenger conveying system with simple driving and a favorable energy consumption.

This object is achieved according to the invention by a passenger conveying system comprising a transport device, in or on which passengers can be conveyed, and an electric motor for driving the transport device, the electric motor being a synchronous linear motor comprising a secondary part in the form of a toothed rack and without any permanent magnets, and the primary part of the synchronous linear motor being fixed to the transport device.

The use of a synchronous linear motor comprising a secondary part without any permanent magnets has the advantage that, firstly, less energy is required for driving purposes in comparison with an asynchronous motor. Secondly, this synchronous linear motor can also be used where otherwise unacceptable contamination of the secondary part is to be expected. A further advantage of a secondary part without any permanent magnets consists in the fact that it does not bring about any magnetic fields which may be damaging to passengers.

In accordance with a particularly preferred configuration, the transport device has a railroad car. This means that a large number of passengers can be conveyed at the same time by the passenger conveying system. In particular, it may be favorable for these railroads with a synchronous linear motor to be used where it is necessary to cope with relatively high inclines and the conventional wheel drive is unsuitable. Examples of this would be subways in certain sections of track and inclined elevators or cogwheel railroads (in this case without the typical gearwheel drive).

In accordance with a preferred development, the passenger conveying system is in the form of a magnetic levitation railroad. Owing to the synchronous linear drive in this case high quantities of energy can be saved.

A further configuration of the passenger conveying system according to the invention consists in the fact that the transport device comprises a car or platform for an elevator. It is thus also possible, for example, for hoisting systems in mining to be operated using synchronous linear technology.

However, the transport device may also have an endless belt. Such passenger conveying systems can then be used as moving walkways, for example in airports. Advantageously, in this case elements of the secondary part are mounted on the segments of the endless belt, and the entire secondary part is driven by one or more primary parts.

Similarly, the transport device may also include an escalator. In this case, too, the secondary part would advantageously be fixed in individual sections to the segments of the escalator. In this case it would be particularly advantageous that the otherwise customary, large area for the motor and the gear mechanism does not need to be maintained at the end of the escalator.

The present invention will now be explained in more detail with reference to the attached drawing, which shows a cross-sectional sketch through a magnetic levitation railroad comprising a synchronous linear motor.

The exemplary embodiments described in more detail below represent preferred embodiments of the present invention.

The exemplary embodiment illustrated in the figure relates to a magnetic levitation railroad as a passenger conveying system. The magnetic levitation railroad has been equipped with a synchronous linear motor, whose secondary part does not have any permanent magnets. Such a synchronous linear motor is described in detail in the German patent application DE 10 2004 045 992.4.

A car K of the magnetic levitation railroad can accommodate several passengers. In each case one primary part P of a synchronous linear motor is fitted to the left and right on the underside of said car. The respective secondary parts S are fixed to a magnetic levitation rail MS. They are in each case guided in a dedicated cutout A of the car K above the primary part P.

The primary parts P have been equipped with permanent magnets (not illustrated). This ensures a basic magnetic flux by means of the secondary parts S in order to bear and drive the car K. Since this basis flux does not need to be applied by electromagnets, a considerable saving in terms of energy is achieved.

In previous models of magnetic levitation railroads, asynchronous linear motors have been used. Owing to the synchronous linear motor comprising the secondary part without any permanent magnets, a higher force density is achieved with the same air gap between the primary part and the secondary part and the same current than in the case of the asynchronous linear motor.

Since, in addition, the secondary parts of the synchronous linear motors do not have any permanent magnets, the rails of the magnetic levitation railroad can likewise be produced in a favorable manner, as in the case of an asynchronous linear motor. Furthermore, the advantage of an asynchronous linear motor that the secondary part(s) is/are not contaminated by ferromagnetic particles is maintained since the permanent magnets are located on the primary part.

The primary parts of the synchronous linear motors of the magnetic levitation railroad need to be supplied with energy. The magnetic levitation railroad or the car K is therefore provided with a current collector, which is not illustrated in the figure.

Further application areas of the synchronous linear motor comprising a secondary part without any permanent magnets, in addition to the applications already mentioned at the outset, also consist in rail-bound and non-rail-bound transport and conveying systems or installations and auxiliary drives therefor, in trolley drives for cranes, in vertical transport systems and in rail-bound traffic systems.

1.-7. (canceled)

8. A passenger conveying system, comprising:
a transport device for transportation of passengers; and
an electric motor for driving the transport device, said electric motor being constructed as a synchronous linear motor comprising a secondary part which is constructed in the form of a toothed rack in the absence of permanent magnets, and a primary part which is fixed to the transport device.

9. The passenger conveying system of claim 8, wherein the transport device has a railroad car.

10. The passenger conveying system of claim 9, constructed in the form of a magnetic levitation railroad.

11. The passenger conveying system of claim 8, wherein the transport device includes a car or platform for an elevator.

12. The passenger conveying system of claim 8, wherein the transport device has an endless belt.

13. The passenger conveying system of claim 8, wherein the transport device includes an escalator.

14. The passenger conveying system of claim 8, wherein the transport device is constructed for rail-less movement, with a transverse guidance between the primary part and the secondary part being realized by magnetic forces.
